(19) United States
(12) Patent Application Publication
(10) Pub. No.: US 2010/0089110 A1
(43) Pub. Date: Apr. 15, 2010

(54) CARBON DIOXIDE SCRUBBING WITH AMMONIUM CARBONATE AND AMMONIA VAPOR CONTROL

(75) Inventors: Joanna Duncan, Springvale, ME (US); Christopher McLarnon, Exeter, NH (US); Francis Alix, Rye, NH (US)

Correspondence Address: Nikolas J. Uhlir;Powerspan Corp., 100 International Drive, SUITE 200, PORTSMOUTH, NH, 03801, US

(73) Assignee: POWERSPAN CORP., Portsmouth, NH (US)

(21) Appl. No.: 12/598,246

(22) PCT Filed: May 9, 2008
(86) PCT No.: PCT/US08/63265

§ 371 Date: Oct. 30, 2009

Related U.S. Application Data
(60) Provisional application No. 60/916,896, filed on May 9, 2007.

(51) Int. Cl. C05C 3/00; B01D 53/14; B01D 53/62; B01D 53/60

(52) U.S. Cl. 71/60; 95/200; 423/237; 204/174

(57) ABSTRACT

A method for removing carbon dioxide from a gas stream and controlling ammonia vapor by scrubbing the carbon dioxide from the gas stream with ammonium carbonate, thereby producing ammonia vapor and ammonium bicarbonate; removing a portion of the ammonia vapor from the gas stream with ammonium bicarbonate; and polishing the flue gas to achieve an ammonia concentration of less than 10 PPM.

### BACKGROUND

1. Field of the Invention

The invention relates to methods and apparatuses for removing carbon dioxide from a gas stream.

2. Description of the Related Art

The absorption of carbon dioxide into ammonium carbonate solutions has been studied for many years, and there is no doubt that ammonium carbonate solutions will capture carbon dioxide from a gas stream, including flue gas. See Mellor, J. W., “A Comprehensive Treatise on Inorganic and Theoretical Chemistry,” Vol. II, 1956. What needs to be addressed and has not been solved in the prior art, however, is (i) can the ammonia vapor be controlled and captured to prevent release of ammonia from the stack, (ii) can the ammonium carbonate be efficiently decomposed back to ammonia and carbon dioxide, and (iii) once released can the ammonia and carbon dioxide be effectively separated to allow the carbon dioxide to be considered sequestration ready and the ammonia to be returned to the other processes for reuse?

What is needed, therefore, is a method and apparatus for scrubbing carbon dioxide from a gas stream that controls ammonia vapor, and returns ammonia reagents to the ammonium carbonate solutions or other processes for reuse.

### SUMMARY

The invention is a method and apparatus that satisfies the need for scrubbing carbon dioxide from a gas stream that controls ammonia vapor, and returns ammonia reagent to ammonium carbonate solutions or other processes for reuse. The invention is a method and apparatus for removing carbon dioxide from a gas stream and controlling ammonia vapor comprising the steps of scrubbing the carbon dioxide from the gas stream with an ammonium carbonate solution, thereby producing ammonia vapor and ammonium bicarbonate; removing a portion of the ammonia vapor from the gas stream with ammonium bicarbonate; and polishing the flue gas to achieve an ammonia concentration of less than 10 ppmv. These and other features, aspects, and advantages of the present invention will become better understood with regard to the following description, claim, and accompanying drawings.

### DRAWINGS

FIG. 1 is a process flow chart showing the carbon dioxide scrubbing method of the present invention.

FIG. 2 is a schematic layout of the scrubbing apparatus according to the present invention.

### DESCRIPTION

The invention is a method and apparatus for removing carbon dioxide from a gas stream and controlling ammonia vapor comprising the steps of scrubbing the carbon dioxide from the gas stream with an ammonium carbonate solution, thereby producing ammonia vapor and ammonium bicarbonate; removing a portion of the ammonia vapor from the gas stream with ammonium bicarbonate; and polishing the flue gas to achieve an ammonia concentration of less than 10 PPM.

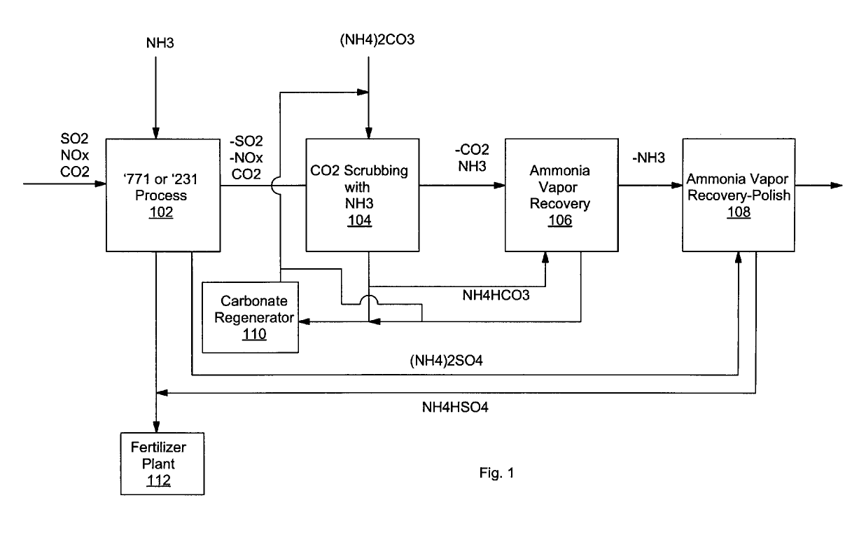

Turning to FIG. 1, flue gas typically contains SO₂, NOₓ, and CO₂. The SO₂ and NOx are preferably processed by the method and apparatus disclosed in U.S. Pat. No. 6,605,263, entitled SULFUR DIOXIDE REMOVAL USING AMMONIA, and U.S. Pat. No. 6,936,231, entitled NOx, Hg, AND SO₂ REMOVAL USING AMMONIA, which are hereby incorporated by reference as if completely rewritten herein. In this specification, these processes will be referred to as the '263 and '231 processes and depicted in the diagram as 102. Although the '263 or '231 processes provide solutions that are the preferred methods for scrubbing NH₃ vapor released during CO₂ scrubbing, as will be shown later in this specification, other processes requiring the addition of ammonia could be used instead of the '263 and '231 processes and would be known to those skilled in the art.

The CO₂ scrubbing process and apparatus can be integral with the apparatus island of the '263 or the '231 process, or it can be in its own tower with ductwork moving flue gas from one tower to the other. Regardless, after either the '263 or '231 process 102, the CO₂ is scrubbed with an ammonium carbonate solution 104. The scrubbing produces ammonia vapor and ammonium bicarbonate, and the scrubbing solution becomes an ammonium carbonate/ammonium bicarbonate solution. A portion of the solution is drawn off to a regeneration step 110.

Another portion of the solution is drawn with the remaining flue gas, having less CO₂, to the first ammonia vapor recovery step 106. However, it is not expected that the ammonium carbonate solution will be able to recover all of the ammonia released during CO₂ scrubbing. Therefore, a second ammonia capture section 108 is necessary to decrease the NH₃ release to less than 10 ppmv.

The second ammonia step is removes or captures any remaining ammonia vapor from the flue gas 108 with solution from the upper loop of either the '263 or '231 process or from the lower loop of the '263 process. The ammonia vapor concentration exiting with the flue gas is <10 ppm. In the '263 and '231 process, the upper loop requires ammonia addition to remove SO₂ and NOₓ and operates with ammonia slip of <10 ppm. The requirement for ammonia addition to the upper loop of the '263 and '231 process in addition to the ability for it to operate with low ammonia slip would enable the CO₂ scrubbing and '263 or '231 process to operate synergistically without ammonia slip. This step is called the polishing step or NH₃ capture step.

When the CO₂ scrubbing step 104 is used in conjunction with the '263 process, the lower loop solution can be used to remove the remaining NH₃ vapor from the flue gas prior to discharge to the atmosphere. The requirement for ammonia in this section is not as high as for the upper loop of the '263 process and therefore will have a smaller capacity for NH₃ vapor, but the lower pH will be a more efficient NH₃ scrubbing liquid and therefore decrease the amount of mass transfer necessary to capture the ammonia vapor. The output of the '263 and '231 process is (NH₄)₂SO₄, which can be collected for turning into fertilizer at a fertilizer plant 112, or can be used in the polishing step 108.

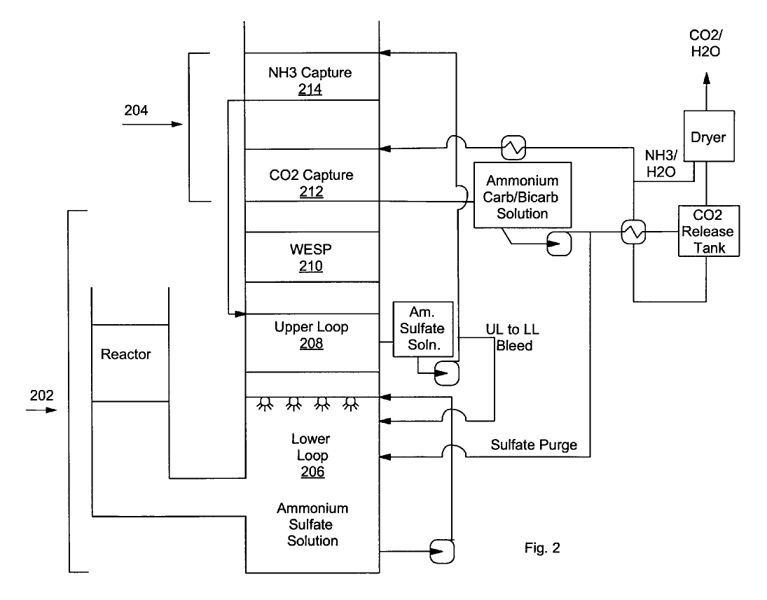

An apparatus according to the present invention is shown in the schematic of FIG. 2. This figure shows one approach for removing NOₓ, SO₂, and CO₂ from flue gas through modification of the '263 process, shown collectively as item 202 and comprising a reactor, lower loop 206, upper loop 208, and WESP 210. A section 204 is added to the process whether it be integral to the '771 process island 202 as shown in the figure or a stand alone tower with ductwork moving flue gas from one tower to the other and back. The initial steps of the process are the first steps of the '771 process: (i) convert NOx to NO₂ in the reactor, (ii) cool the flue gas stream to saturation in the lower loop, (iii) remove the NO₂ and SO₂ in the ‘upper loop’ of the absorber, and (iv) remove aerosols using a wet ESP (“WESP”).

The apparatus can also be modified to work in conjunction with the '231 process shown collectively as item 202 and comprising a lower loop 206 and WESP 210. A section 204 is added to the process whether it be integral to the '231 process island 202 as shown in the figure or a stand alone tower with ductwork moving flue gas from one tower to the other. The initial steps of the process are the first steps of the '231 process: (i) cool the flue gas stream to saturation in the lower loop, (ii) remove the SO₂ in the absorber, and (iii) remove aerosols with a WESP.

In order to capture CO₂, additional mass transfer sections are needed and are collectively shown as the new CO₂ and NH₃ absorption mass transfer section 204. This section will be used to remove CO₂ and NH₃ using ammonium carbonate. The CO₂ removal 212 and NH₃ capture section 214 can either be separated with a liquid redistribution tray to allow the regeneration products to be added prior to the CO₂ mass transfer section or by a separator tray to allow the liquid used to capture ammonia vapor be sent directly to regeneration. The scrubbing solution is a mixture of ammonium carbonate and bicarbonate and preferably has a carbonate concentration between 3-25 wt %. The ammonium carbonate/bicarbonate solution enters the top of the NH₃/CO₂ removal section ‘NH₃ lean’ or ‘CO₂ rich’ because it has previously been used to absorb carbon dioxide increasing the bicarbonate/carbonate ratio and decreasing the pH. Due to the increase in bicarbonate and lower pH, this solution will be able to absorb NH₃ according to the following reaction:

HCO₃⁻+NH₃→NH₄⁺+CO₃²⁻ (1)

Once the NH₃ has been absorbed, the solution will be captured in a liquid redistribution tray and NH₃/H₂O will be added from a regeneration step, which is not a part of this specification. The addition of the NH₃/H₂O will further decrease the bicarbonate/carbonate ratio (meaning the solution is ‘NH₃ rich’ or ‘CO₂ lean’) and will be able to absorb CO₂ from the flue gas stream.

Although the preferred embodiments of the present invention have been described herein, the above description is merely illustrative. Further modification of the invention herein disclosed will occur to those skilled in the respective arts and all such modifications are deemed to be within the scope of the invention as defined by the appended claims.

We claim:

1. A method for removing carbon dioxide from a gas stream and controlling ammonia vapor comprising the steps of:
providing a gas stream comprising carbon dioxide, and SO₂;
scrubbing the carbon dioxide from the gas stream with ammonium carbonate, thereby producing ammonium bicarbonate and ammonia vapor;
removing a portion of the ammonia vapor from the gas stream with ammonium bicarbonate; and
further capturing the ammonia vapor in the flue gas to achieve an ammonia vapor concentration of less than 10 ppmv using an ammonium bisulfate solution and producing ammonium sulfate from ammonium bisulfate.

2. The method of claim 1, wherein the gas stream also contains NOx.

3. The method of claim 2 further comprising the steps before the carbon dioxide scrubbing step of:
oxidizing at least a portion of NO in the gas stream to NO₂ with an oxidizing means;
scrubbing at least a portion of SO₂, NO, and NO₂ from the gas stream with an ammonia scrubbing solution comprising ammonia; and
removing at least a portion of any ammonia aerosols generated from the SO₂, NO, and NO₂ scrubbing step from the gas stream with an aerosol removal means.

4. The method of claim 1, further comprising the steps before the carbon dioxide scrubbing step of:
scrubbing at least a portion of SO₂ from the gas stream with an ammonia scrubbing solution comprising ammonia; and
removing at least a portion of any ammonia aerosols generated from the SO₂ scrubbing step from the gas stream with an aerosol removal means.

5. The method of claim 2, further comprising the step of adding ammonium sulfate from the NH₃ capture step to the SO₂, NO, and NO₂ scrubbing step, thereby operating the process synergistically and without ammonia slip.

6. The method of claim 3, further comprising the step of adding ammonium sulfate from the NH₃ capture step to the SO₂ scrubbing step, thereby operating the process synergistically and without ammonia slip.

7. The method of claim 3, wherein the SO₂, NO, and NO₂ scrubbing step produces ammonium sulfate and ammonium bisulfate.

8. The method of claim 4, further comprising the step of collecting the produced ammonium sulfate for fertilizer.

9. The method of claim 4, further comprising the step of providing at least some of the produced ammonium sulfate for the NH₃ capture step.

10. The method of claim 1, further comprising the steps before the carbon dioxide scrubbing step of:
converting NOx to NO₂ in a reactor;
cooling the flue gas stream to saturation in a lower loop of an absorber having an upper loop and a lower loop, thereby producing aerosols;
removing NO₂ and SO₂ in the upper loop of the absorber; and
removing the aerosols with a wet electrostatic precipitator.

11. The method of claim 1, further comprising the steps before the carbon dioxide scrubbing step of:
cooling the flue gas stream to saturation in a lower loop of an absorber having an upper loop and a loop, thereby producing aerosols;
removing SO₂ in the absorber; and
removing the aerosols with a wet electrostatic precipitator.

12. The method of claim 1, the carbon dioxide scrubbing step using a scrubbing solution of ammonium carbonate and ammonium bicarbonate having a total carbonate concentration between 3 and 25 wt %.
